(19) United States
(12) Patent Application Publication
(10) Pub. No.: US 2006/0091204 A1
(43) Pub. Date: May 4, 2006

(54) Magnetic ticket and contactless ticket dispensing machine

(76) Inventor: Patrick Le Gal, Saint Peray (FR)

Correspondence Address: PLEVY & HOWARD, P.C., P.O. BOX 226, FORT WASHINGTON, PA, 19034, US

(21) Appl. No.: 11/253,382

(22) Filed: Oct. 19, 2005

(30) Foreign Application Priority Data
Oct. 28, 2004 (FR) 04/52473

(51) Int. Cl. G06F 7/08

(52) U.S. Cl. 235/381

(57) ABSTRACT

A machine for dispensing tickets of a first type or of a second type, each ticket of the first type comprising, on a determined portion, a magnetic track, said machine comprising drive means for having each ticket of the first type and of the second type pass in front of a magnetic head capable, on passing of a ticket of the first type, of reading and/or writing data on the magnetic track; a shaft supporting a roller; and means for moving the roller along the shaft between, on passing of a ticket of the first type, a first position at which the roller forces the determined portion of the ticket against the magnetic head and, on passing of a ticket of the second type, a second position at which the roller does not face the magnetic head.

### FIELD OF THE INVENTION

The present invention relates to magnetic ticket and contactless ticket dispensing devices.

### DISCUSSION OF THE RELATED ART

There exist, for example, for the use of public transports, dispensing machines delivering to a user, against payment, transport tickets. Transport tickets for example are of magnetic type and are then formed of a board rectangular support on which a magnetic track is deposited. The dispensing machine then comprises a magnetic head to write data on the magnetic track of the ticket before providing it to the user.

Magnetic tickets tend to be more and more replaced with contactless read/write tickets, which will be called contactless tickets hereafter. A contactless ticket is formed, for example, of a stacking of cardboard or plastic layers in which is arranged a chip connected to an antenna. The reading and the writing of data at the chip level can be performed via a contactless read/write circuit, generally called an antenna circuit. Contactless circuits exhibit a higher security level and allow a greater data storage at the chip level. In a transition phase, magnetic tickets and contactless tickets will necessarily have to be both available to enable users to progressively get used to the use of contactless tickets. Further, it is most likely for the use of magnetic tickets never to be completely interrupted. To avoid multiplying dispensing machines, it is desirable for dispensing machines to be able to deliver, on request of the user, magnetic tickets or contactless tickets.

In a conventional magnetic ticket dispensing machine, the forming of a magnetic ticket first comprises a step of cutting the end of a roll and a step of printing, on the cut ticket, data such as the emission date, the end-of-validity date, etc. or decorative elements. Each ticket is then moved in front of a magnetic head for the writing of data on the magnetic track of the ticket. The ticket is then delivered to the user. For a conventional contactless ticket dispensing machine, the contactless ticket is maintained in front of a contactless read and write circuit for the writing of data on the ticket chip.

A solution to form a magnetic ticket and contactless ticket dispensing machine is to provide a dispensing machine in which the manufacturing of the magnetic tickets and the manufacturing of the contactless tickets are performed separately on two separate manufacturing lines. A disadvantage of such a solution is that it requires duplicating certain components, especially the cutting device and the printing device, with respect to a conventional dispensing machine, and thus causes an increase in the dispensing machine selfcost. Further, the tickets being displaced on separate manufacturing lines, this causes an increase in the dispensing machine bulk.

It would thus be desirable to be able to use a magnetic ticket and contactless ticket dispensing machine for which the magnetic tickets and the contactless tickets would be displaced on a same manufacturing line. This would enable using the same cutting and printing devices for magnetic tickets and contactless tickets. The dispensing machine would then comprise, on a same manufacturing line, both a contactless read/write circuit, activated when the ticket would be of contactless type only, and a magnetic head, activated when the ticket would be of magnetic type only. Each ticket, of magnetic type or of contactless type, would then pass in front of the magnetic ticket and the antenna circuit, but only the magnetic head or the antenna circuit would be activated according to the nature of the ticket.

Currently, an operation of writing on a magnetic track of a magnetic ticket by a magnetic head requires displacing the ticket in front of the magnetic head while ensuring a close contact between the magnetic track and the magnetic head. For this purpose, the portion of the magnetic ticket supporting the magnetic track is generally sandwiched between the magnetic head and a driving roller which presses said portion of the magnetic ticket against the magnetic head while running the ticket. The interstice provided between the driving roller and the magnetic head is generally on the order of from 5 to 7 hundredths of a millimeter to ensure a proper contact between the magnetic track and the magnetic head, whatever the thickness of the magnetic ticket. Currently, according to the different existing standards, the thicknesses of magnetic tickets generally vary from 0.17 mm to 0.27 mm. An interstice from 5 to 7 hundredths of a millimeter then ensures a sufficient contact, even for a magnetic ticket of a 0.17-mm thickness.

For a magnetic ticket and contactless ticket dispensing machine having a single ticket manufacturing line, each contactless ticket should pass in the interstice between the driving roller and the magnetic head. However, currently-available contactless tickets generally have a thickness greater than 0.34 mm, the thickness of the contactless ticket being even likely to locally reach 0.45 mm at the chip level. The greater thickness of a contactless ticket with respect to that of a magnetic ticket risks causing, in the passing through the interstice, a shock which might overstrain the motor rotating the driving roller and accelerate the wearing of magnetic head. Further, there would exist a risk of premature wearing of the driving roller due to the additional pressure exerted thereon. Moreover, the contactless ticket would risk being damaged by the lamination exerted by the driving roller, especially by a deterioration of the antenna or of the connection between the antenna and the chip. Further, the actual chip would risk being damaged if it was placed at the level of the portion of the contactless ticket sandwiched between the driving roller and the magnetic head. Since current standards do not impose an accurate position of the chip at the level of the contactless ticket, this risk could not be discarded.

### SUMMARY OF THE INVENTION

The present invention aims at obtaining a magnetic ticket and contactless ticket dispensing machine having a single ticket manufacturing line, exhibiting no risk of damaging the contactless tickets as they pass at the level of the magnetic head.

According to another object, the present invention aims at obtaining a dispensing machine of simple design and at low cost.

To achieve these objects, the present invention provides a machine for dispensing tickets of a first type or of a second type, each ticket of the first type comprising, on a determined portion, a magnetic track, said machine comprising drive means for having each ticket of the first type and of the second type pass at the level of a magnetic head capable, on passing of a ticket of the first type, of reading and/or writing data on the magnetic track; a shaft supporting a roller; and means for moving the roller along the shaft between, on passing of a ticket of the first type, a first position at which the roller applies the determined portion of the ticket against the magnetic head and, on passing of a ticket of the second type, a second position at which the roller does not face the magnetic head.

According to an embodiment of the present invention, each ticket of the second type comprises an integrated circuit and an antenna connected to the integrated circuit.

According to an embodiment of the present invention, the machine comprises a fixed wall, the displacement means comprising a lever pivotally assembled on the fixed wall and having an end connected to the roller.

According to an embodiment of the present invention, the displacement means comprise at least one part comprising two sides extending on either side of the roller, each side being slidably assembled on the shaft, the lever being capable of exerting a thrust on the part along the shaft axis.

According to an embodiment of the present invention, the lever comprises an opening, a cylindrical connection element being connected to the part and cooperating with the opening.

According to an embodiment of the present invention, the displacement means comprise an actuator capable of displacing an arm pivotally assembled, at one end, on the lever.

According to an embodiment of the present invention, the actuator is capable of displacing the roller from the first (conversely, the second) position to the second (conversely, the first) position, the displacement means comprising resilient means for pulling-back the roller from the second (conversely, the first) position to the first (conversely, the second) position.

According to an embodiment of the present invention, the machine comprises means for rotating the shaft, the roller being rotated by the shaft and assembled to freely slide on the shaft.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 is a simplified cross-section view of an example of the forming of a magnetic ticket and contactless ticket dispensing machine according to the present invention;

FIG. 2 is a perspective view of the dispensing machine of FIG. 1 at the level of the magnetic head; and

FIGS. 3 and 4 illustrate the operation of the dispensing machine according to the present invention.

### DETAILED DESCRIPTION

For clarity, same elements have been designated with same reference numerals in the different drawings.

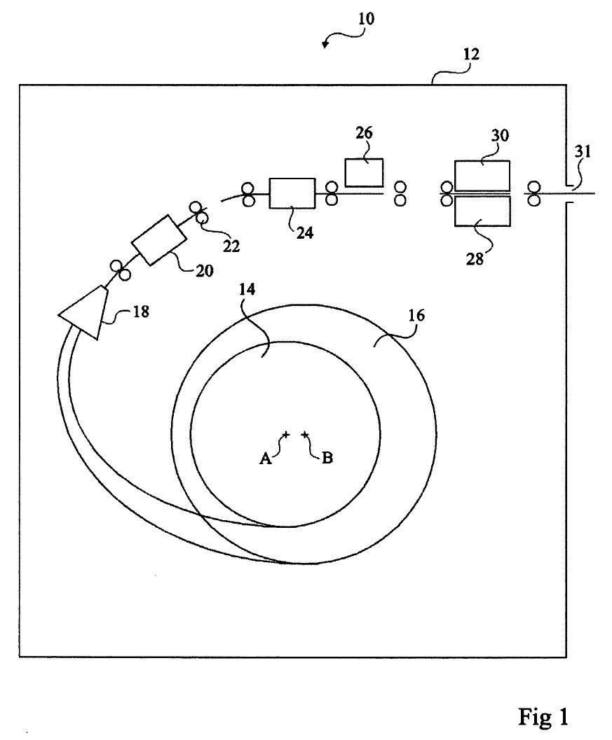

FIG. 1 very schematically shows an example of the forming of a magnetic ticket and contactless tickets dispensing machine 10 according to the present invention. Dispensing machine 10 comprises a package 12 in which are arranged two rolls 14, 16, one roll for the magnetic ticket manufacturing and one roller for the contactless ticket manufacturing. Each roll 14, 16 is assembled to freely rotate around an axis, respectively A and B. The free end of each roll 14, 16 is inserted into a selection device 18 which provides the ends of rolls 14, 16 to a cutting device 20. When a user orders a ticket, via an interface unit not shown, selection device 18 moves forward, according to the type of the ticket that the user has ordered, the end of magnetic ticket roll 14 or the end of contactless ticket roll 16 into cutting device 20 by a distance corresponding to the length of a ticket. The ticket is then cut and displaced by drive rollers 22 towards a printing device 24 capable of printing patterns and/or data on one and/or the other of the ticket surfaces. The ticket then passes at the level of a contactless read/write circuit 26. If it is a contactless ticket, the ticket is positioned above the contactless read/write circuit 26 for the writing of data on the contactless ticket chip and the checking of the written data. The ticket then passes at the level of a magnetic head. If it is a magnetic ticket, the ticket performs a reciprocating motion in front of magnetic head 28 for the writing of data on the magnetic track of the ticket and the checking of the written data. A pushing device 30 then applies the magnetic ticket against magnetic head 28 with a sufficient pressure to ensure the proper conduct of the write and checking operations. If the ticket is a contactless ticket, pushing device 30 does not press the ticket against magnetic head 28, thus avoiding any deterioration of magnetic head 28 or of the ticket. Package 12 comprises an opening 31, or any other adapted device, for delivering the ticket to the user.

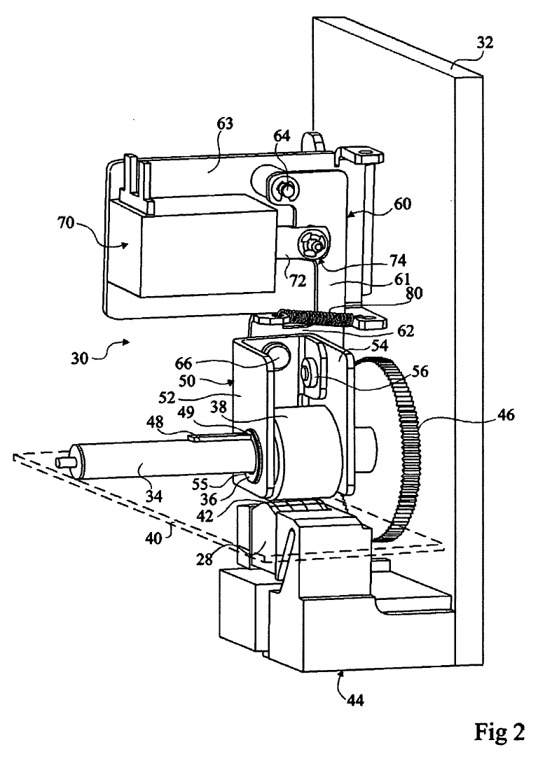

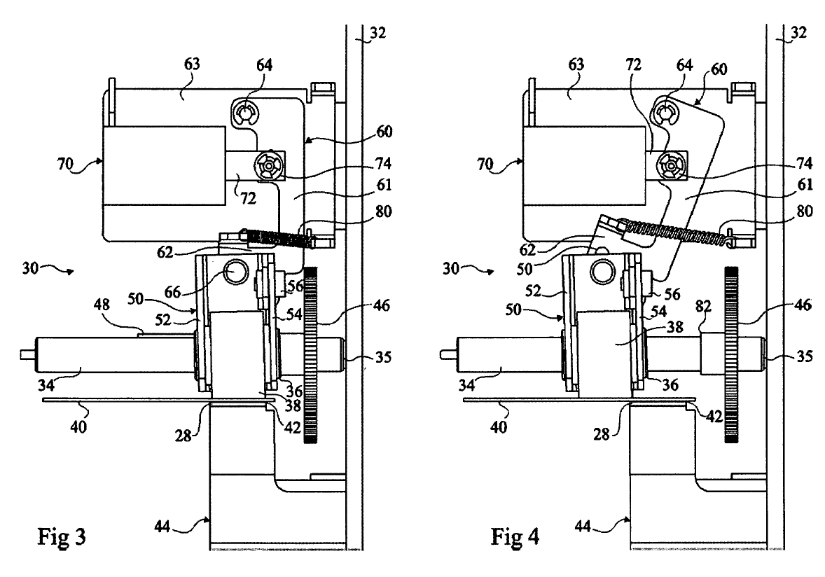

FIGS. 2 and 3 respectively are a perspective view and a front view of an example of the forming of pushing device 30 according to the present invention and of magnetic head 28 of FIG. 1 in an arrangement adapted to the passing of a magnetic ticket. FIG. 4 is a front view, similar to FIG. 3, for which pushing device 30 is in an arrangement adapted to the passing of a contactless ticket.

For clarity, only those elements taking part in the present invention have been shown. In particular, a portion only of package 12 is shown in FIGS. 2 to 4 as a wall 32. Pushing device 30 comprises a dive shaft 34 maintained at one end by a bearing 35 at the level of wall 32, the other end of shaft 34 being maintained by a bearing supported by a wall, not shown. A hub 36 is assembled on shaft 34 and supports a driving roller 38. A ticket 40 has been shown in dotted lines in FIG. 2 and in full lines in FIGS. 3 and 4 on passing thereof at the level of magnetic head 28.

In the position shown in FIGS. 2 and 3, driving roller 38 defines with magnetic head 28 an interstice 42 for the passing of ticket 40. In the present example of embodiment, the magnetic track of a magnetic ticket is arranged on the lower surface of the magnetic ticket and along the left-hand side, in an orientation according to the general moving direction of the ticket towards outlet 31 of dispensing machine 10. Magnetic head 28 is maintained by a support 44 attached to wall 32 to, on passing of a magnetic ticket, substantially face the magnetic track of the magnetic ticket. The rotating of shaft 34 is performed by a toothed wheel 46 actuated via a pinion system not shown.

The principle of present invention consists, when ticket 40 intended to pass in interstice 42 is of contactless type, of sliding hub 36, and thus driving roller 38, along shaft 34 to a position at which driving roller 38 is no longer opposite to magnetic head 28. Thereby, on passing of the contactless ticket, the ticket portion which passes facing magnetic head 28 is not laminated by driving roller 38.

For this purpose, pushing device 30 comprises a key 48 attached to drive shaft 34, which extends along a portion of a generating line of drive shaft 34 and which penetrates into a groove 49 provided at the level of hub 36. The cooperation of key 48 and of groove 49 enables the rotating of hub 36 and roller 38 by drive shaft 34, while allowing sliding of hub 36 and of roller 38 along shaft 34. The displacement of hub 36 and of roller 38 is ensured by a shell 50, formed of two half-shells 52, 54 attached to each other by an attachment system 56. Each half-shell 52, 54 comprises a cylindrical opening 55 for the passing of shaft 34 and of an end of hub 36.

The displacement of shell 50 is ensured by a lever 60 comprising a first arm 61 having one end connected to a second arm 62, the two arms 61, 62 extending in substantially perpendicular directions. First arm 61 is connected, at its end opposite to second arm 62, to a flange 63 via a pivotal link 64. Flange 63 is solid with wall 32. Second arm 62 comprises, at its end opposite to first arm 61, an elongated opening 65, visible in FIG. 4 only, in which is placed an axis 66 on which shell 50 is pivotally assembled.

An actuator 70, for example, of magnetic actuator type, is attached to flange 63 and is capable, under the action of control signals, of moving a drive arm 72 substantially along the direction of drive shaft 34. The end of arm 72 opposite to actuator 70 is pivotally assembled by a pivotal connection 74 on first arm 61 of level 60 between pivotal connection 64 and the end of first arm 61 connected to second arm 62. The assembly is formed so that in idle position, that is, in the absence of activation of actuator 70, arm 72 is as far outside as possible of actuator 70 so that driving roller 38 faces magnetic head 28 as shown in FIGS. 2 and 3. When actuator 70 is activated, arm 72 enters the body of actuator 70, causing the pivoting of lever 60 around pivotal connection 64. Arm 62 exerts a thrust on shaft 66, which causes the displacement of shell 50 along shaft 34. In the pivoting of lever 60, shaft 66 moves in opening 65 of arm 62. A pull-back device enables bringing drive shaft 38 back to the idle position, when actuator 70 is no longer activated. The pull-back device is, in the present example of embodiment, formed of a spring 80 having one end attached to lever 60, substantially at the level of the connection between lever 60 and shell 50, and having its other end attached at the level of flange 63. In FIG. 4, spring 80 is schematically shown in dotted lines.

FIG. 3 shows the idle position of drive shaft 38 when actuator 70 is not activated.

As shown in FIG. 4, when actuator 70 is activated, drive shaft 38 is moved to no longer be substantially opposite to magnetic head 28.

Advantageously, drive shaft 34 may comprise a shoulder 82 enabling blocking the sliding of shell 50 and of hub 36 when driving roller 38 is pulled back by spring 80 to its idle position.

The present invention has many advantages.

First, it enables use of a ticket dispensing machine both for magnetic tickets and contactless tickets without requiring two separate lines for the manufacturing of magnetic tickets and of contactless tickets. Certain devices can then be used in common for the two types of tickets, especially the cutting device and the printing device.

Second, the present invention enables use of magnetic tickets and of contactless tickets having different thicknesses. More specifically, it enables use of contactless tickets having a thickness greater than that of magnetic tickets without damaging the contactless tickets.

Third, the present invention enables maintaining the magnetic head in a fixed position on passing of the tickets. This is advantageous since the position of the magnetic head is obtained by an accurate setting difficult to perform if the magnetic head is mobile.

Fourth, the spacing of the roller for the passing of a contactless ticket is obtained by a device sliding the driving roller along the shaft supporting it. Such kinematics enable limiting the stress applied to the parts taking part in the roller movement when said roller exerts a pressure on a magnetic ticket against the magnetic head. Indeed, such stress is then essentially supported by the support shaft of the roller. If a device had been provided to move away from the magnetic head the assembly formed by the shaft and the roller in the passing of a contactless ticket, this same device would necessarily take part in the pushing, by the drive shaft, of a magnetic ticket against the magnetic head. Such a device would thus in return undergo high stress in the pushing by the roller of a magnetic ticket against the magnetic head. The forming of such a device would be more delicate. On the contrary, for the pushing device according to the present invention, the stress undergone by the roller on pressing of a magnetic ticket against the magnetic head is not, for its major part, transmitted to the device enabling sliding the roller on the shaft. The design of the pushing device according to the present invention is thereby simplified.

Fifth, the displacement of the driving roller is obtained by a relatively simple mechanical system that can be formed at low cost.

Of course, the present invention is likely to have various alterations, modifications, and improvements which will readily occur to those skilled in the art. In particular, the present invention has been described for a magnetic ticket dispensing machine for which the magnetic track is located along an edge of the magnetic ticket. Such may not be the case. For example, the magnetic track may be located in the central portion of the magnetic ticket. In this case, the magnetic head is placed to be substantially opposite to the central portion of the tickets on passing of magnetic tickets. In this case, it is preferable for the preceding assembly to be formed so that, at rest, driving roller 38 is maintained at the level of the central portion of the ticket to ensure the putting in contact of the ticket against the magnetic head. Further, in the present example of embodiment, magnetic head 28 and driving roller 38 are substantially shown according to a vertical alignment, magnetic head 28 being shown under driving roller 38. It should be clear that the relative positions between magnetic head 28 and driving roller 38 are to be adapted according to the orientation of the magnetic ticket on passing thereof at the level of the magnetic head and of the ticket surface on which the magnetic track is located. Further, in the previously-described examples, the idle position corresponds to the passing of a magnetic ticket. Conversely, it may be desirable for the idle position of the pushing device to correspond to the passing of a contactless ticket. The pushing device according to the present invention should thus be adapted accordingly.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A machine (10) for dispensing tickets (40) of a first type or of a second type, each ticket of the first type comprising, on a determined portion, a magnetic track, said machine comprising:
drive means (34, 38) for having each ticket of the first type and of the second type pass in front of a magnetic head (28) capable, on passing of a ticket of the first type, of reading and/or writing data on the magnetic track;
a shaft (34) supporting a roller (38); and
means (50, 60, 70) for moving the roller along the shaft between, on passing of a ticket of the first type, a first position at which the roller forces the determined portion of the ticket against the magnetic head and, on passing of a ticket of the second type, a second position at which the roller does not face the magnetic head.

2. The dispensing machine of claim 1, wherein each ticket of the second type comprises an integrated circuit and an antenna connected to the integrated circuit.

3. The dispensing machine of claim 1, comprising a fixed wall (32), the roller moving means (50, 60, 70) comprising a lever (60) pivotally assembled on the fixed wall and having an end connected to the roller (38).

4. The dispensing machine of claim 3, wherein the roller moving means (50, 60, 70) comprise at least one part (50) comprising two sides extending on either side of the roller (38), each side being slidably assembled on the shaft (34), the lever (60) being capable of exerting a force on the part along the shaft axis.

5. The dispensing machine of claim 4, wherein the lever (60) comprises an opening (65), a cylindrical connection element (66) being connected to the part (50) and cooperating with the opening.

6. The dispensing machine of claim 3, wherein the roller moving means comprise an actuator (70) capable of displacing an arm (72) pivotally assembled, at one end, on the lever (60).

7. The dispensing machine of claim 6, wherein said actuator (70) is capable of displacing the roller (38) from the first (conversely, the second) position to the second (conversely, the first) position, said roller moving means comprising resilient means (80) for pulling back the roller from the second (conversely, the first) position to the first (conversely, the second) position.

8. The dispensing machine of claim 1, comprising means for rotating the shaft (34), the roller (38) being rotated by the shaft and assembled to freely slide on the shaft.
